(19) United States
(12) Patent Application Publication
(10) Pub. No.: US 2026/0110433 A1
(43) Pub. Date: Apr. 23, 2026

(54) COMBUSTOR NOZZLE, AND COMBUSTOR AND GAS TURBINE INCLUDING SAME

(71) Applicant: Doosan Enerbility Co., LTD., Changwon-si, Gyeongsangnam-do (KR)

(72) Inventors: Young Gun GO, Yongin-si, Gyeonggi-do (KR); Kyoung Taek Oh, Hwaseong-si, Gyeonggi-do (KR); Sang Pil Jo, Sejong-si (KR); Joong Hyun Lim, Changwon-si, Gyeongsangnam-do (KR)

(21) Appl. No.: 18/916,232

(22) Filed: Oct. 15, 2024

(30) Foreign Application Priority Data
Oct. 19, 2023 (KR) 10-2023-0140004

(51) Int. Cl. F23R 3/28

(52) U.S. Cl. CPC F23R 3/286

(57) ABSTRACT

Proposed are a combustor nozzle, and a combustor and a gas turbine including the combuster nozzle. The combustor nozzle includes a plurality of mixing tubes spraying a mixture fluid of air and fuel into spray holes, a rear plate supporting the mixing tubes at each rear end of the mixing tubes, and a fuel supply part mounted in the rear plate and configured to supply fuel. Each outlet of a portion of the mixing tubes is formed at a position corresponding to the fuel supply part. Therefore, since inclination angles are provided in the mixing tubes adjacent to the fuel supply part in the combustor nozzle of the gas turbine so that each outlet of the mixing tubes is evenly disposed, an empty space between each of the mixing tubes is not formed, so that overheating of each outlet of the mixing tubes due to heat concentration may be prevented.

### CROSS REFERENCE TO RELATED APPLICATION

The present application claims priority to Korean Patent Application No. 10-2023-0140004, filed on Oct. 19, 2023, the entire contents of which are incorporated herein for all purposes by this reference.

### BACKGROUND OF THE INVENTION

### Field of the Invention

The present disclosure relates to a combustor nozzle, and a combustor and a gas turbine that include the combustor nozzle. More particularly, the present disclosure relates to a combustor nozzle configured such that compressed air supplied from a compressor is mixed with fuel containing hydrogen and a mixture of the compressed air and the fuel is combusted and then a generated combustion gas is supplied to a turbine, and relates to a combustor and a gas turbine that include the combustor nozzle.

### Description of the Related Art

Referring to the related art disclosed in Korean Patent No. 10-2403750, a gas turbine is a power engine that mixes air compressed by a compressor with fuel for combustion and rotates a turbine with hot gas produced by the combustion. The gas turbine is used to drive a generator, an aircraft, a ship, a train, and so on.

Generally, the gas turbine includes a compressor, a combustor, and a turbine. The compressor suctions and compresses outside air, and then transmits the compressed air to the combustor. The air compressed by the compressor has a high pressure and a high temperature. The combustor mixes the compressed air introduced from the compressor with fuel and combusts a mixture of the compressed air and the fuel. Combustion gas produced by the combustion is discharged to the turbine.

Turbine blades in the turbine are rotated by the combustion gas, thereby generating power. The generated power is used in various fields, such as generating electric power, actuating machines, and so on.

Fuel is sprayed through nozzles mounted in each combustor, and the nozzles may be configured to spray gas fuel and liquid fuel. Recently, it is recommended to use hydrogen fuel or fuel containing hydrogen so as to inhibit the emission of carbon dioxide.

A hydrogen mono-combustor is provided with a tube-type fuel nozzle (a tube-type multi-nozzle) having a diameter smaller than that of a normal gas mono-combustor, and a conventional tube-type fuel nozzle is configured such that each nozzle is disposed parallel to each other, so that there is an empty space between each of the nozzles due to a separate fuel supplying structure serving to supply fuel to each of the nozzles. Therefore, there is a disadvantage that a risk of overheating at each outlet surface of the nozzles due to heat concentration in the empty space, and there is a problem that a separate cooling technology for solving this disadvantage is required to be additionally applied.

### SUMMARY OF THE INVENTION

Accordingly, the present disclosure has been made keeping in mind the above problems occurring in the related art, and an objective of the present disclosure is to provide a combustor nozzle and to provide a combustor and a gas turbine that include the combustor nozzle configured such that mixing tubes disposed adjacent to a fuel supply part in the combustor nozzle configured to combust fuel containing hydrogen have angles so that each outlet of the mixing tubes is disposed at a region corresponding to the fuel supply part, the combustor nozzle being configured such that an empty space generated between each mixing tube due to the fuel supply part is prevented from occurring so that overheating of each outlet of the mixing tubes due to heat concentration is prevented.

In order to achieve the objective described above, according to the present disclosure, there is provided a combustor nozzle including: a plurality of mixing tubes configured to spray a mixture fluid in which air and fuel are mixed with each other into respective spray holes; a rear plate supporting the plurality of mixing tubes at each rear end of the plurality of mixing tubes; and a fuel supply part mounted in the rear plate and configured to supply fuel, wherein a portion of the plurality of mixing tubes is formed such that each outlet of the portion of the plurality of mixing tubes is formed at a position corresponding to the fuel supply part.

The combustor nozzle of the present disclosure may further include a mixing mechanism provided in each of the plurality of mixing tubes and configured to mix air and fuel that are supplied into the plurality of mixing tubes, and may further include a front plate supporting the plurality of mixing tubes at each front end of the plurality of mixing tubes. Furthermore, the front plate may include a center region corresponding to the fuel supply part, and may include an outer region surrounding the center region. Furthermore, each outlet of a portion of the plurality of mixing tubes may be disposed in the center region and each remaining outlet of the plurality of mixing tubes may be disposed in the outer region.

The plurality of mixing tubes may include: a center nozzle group having each outlet disposed in the center region; and an outer nozzle group having each outlet disposed in the outer region. Furthermore, an insertion hole into which the fuel supply part is inserted may be formed in a center portion of the rear plate, and a plurality of through holes through which the plurality of mixing tubes penetrates may be formed outside the insertion hole. Furthermore, a plurality of mounting holes in which the plurality of mixing tubes penetrating the plurality of through holes is mounted may be formed in the front plate.

The plurality of mounting holes may be evenly distributed at equal intervals on an entire surface of the front plate, the plurality of mixing tubes may be configured such that the center nozzle group and the outer nozzle group have angles different from each other, and the plurality of mixing tubes mounted in the plurality of mounting holes formed in the front plate may be configured such that each inclination angle of the plurality of mixing tubes is gradually increased from an outer portion of the front plate to a center portion of the front plate.

A fuel inlet hole into which fuel supplied through the fuel supply part is introduced inside each of the plurality of the mixing tubes may be formed in each of the plurality of the mixing tubes, and each mixing mechanism may be provided between each fuel inlet hole and each spray hole.

In addition, according to the present disclosure, there is provided a combustor including: a burner having a plurality of nozzles for spraying fuel and air; and a duct assembly coupled to a first side of the burner, the duct assembly having an inner portion where fuel and air sprayed from the burner are combusted and being configured to transmit combustion gas to a turbine, wherein each of the plurality of nozzles includes: a plurality of mixing tubes configured to spray a mixture fluid in which air and fuel are mixed with each other into respective spray holes; a rear plate supporting the plurality of mixing tubes at each rear end of the plurality of mixing tubes; and a fuel supply part mounted in the rear plate and configured to supply fuel, wherein a portion of the plurality of mixing tubes is formed such that each outlet of the portion of the plurality of mixing tubes is formed at a position corresponding to the fuel supply part.

In addition, according to an embodiment of the present disclosure, there is provided a gas turbine including: a compressor configured to compress air introduced from outside; a combustor configured to mix fuel with air compressed from the compressor and to combust a mixture thereof; and a turbine that comprises a plurality of turbine blades configured to be rotated by combustion gas generated from the combustor, wherein the combustor includes: a burner having a plurality of nozzles for spraying fuel and air; and a duct assembly coupled to a first side of the burner, the duct assembly having an inner portion where fuel and air sprayed from the burner are combusted and being configured to transmit combustion gas to the turbine, wherein each of the plurality of nozzles includes: a plurality of mixing tubes configured to spray a mixture fluid in which air and fuel are mixed with each other into respective spray holes; a rear plate supporting the plurality of mixing tubes at each rear end of the plurality of mixing tubes; and a fuel supply part mounted in the rear plate and configured to supply fuel, and wherein a portion of the plurality of mixing tubes is formed such that each outlet of the portion of the plurality of mixing tubes is formed at a position corresponding to the fuel supply part.

In the combustor nozzle, and the combustor and the gas turbine that include the combustor nozzle according to the present disclosure, since inclination angles are provided in the mixing tubes disposed adjacent to the fuel supply part in the combustor nozzle of the gas turbine so that each outlet of the plurality of mixing tubes is disposed at the position corresponding to the fuel supply part, the empty space between each of the mixing tubes is not formed by the fuel supply part, so that overheating of each outlet of the mixing tubes due to heat concentration may be prevented. Furthermore, since a self-cooling effect of each of the mixing tubes generated by a low temperature fluid flow in each of the mixing tubes is uniformly applied to the entire outlet surface of the plurality of mixing tubes, each outlet of the mixing tubes may be maintained at a uniform temperature.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a gas turbine according to an embodiment of the present disclosure;

FIG. 2 is a view illustrating a combustor in FIG. 1;

FIG. 3 is a cross-sectional view illustrating a part of the combustor in FIG. 2;

FIG. 3 is a view illustrating a burner in FIG. 2 when viewed from the front;

FIG. 4 is a cross-sectional view illustrating a nozzle in FIG. 3 taken along a longitudinal direction;

FIG. 5 is a cross-sectional view taken along line A-A in FIG. 4; and

FIG. 6 is a cross-sectional view taken along line B-B in FIG. 4.

### DETAILED DESCRIPTION OF THE INVENTION

Hereinafter, an exemplary embodiment of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

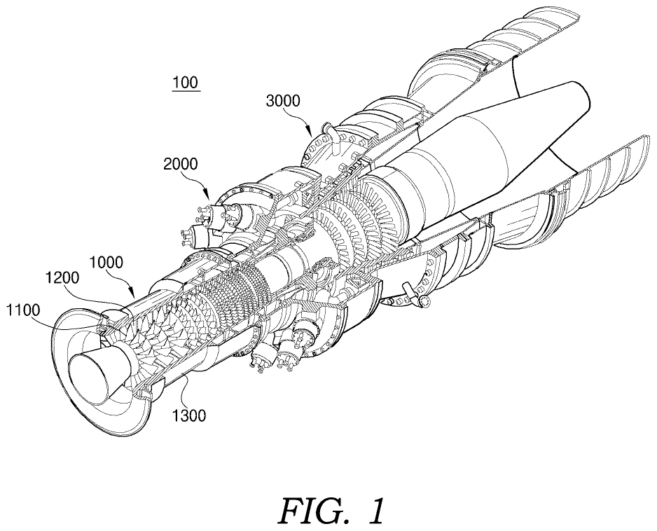

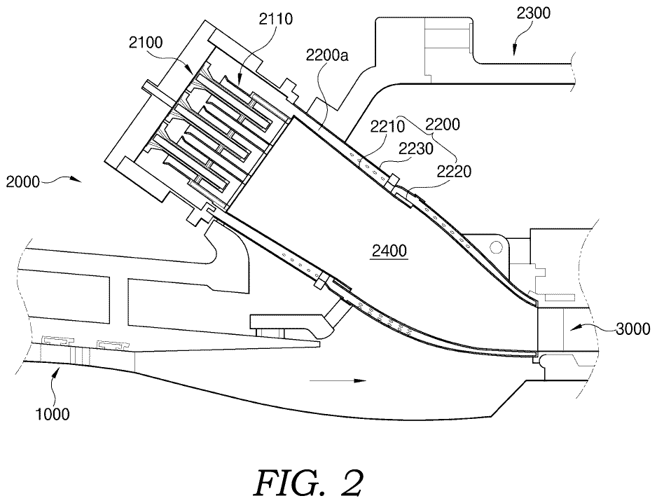

Referring to FIG. 1 and FIG. 2, a thermodynamic cycle of a gas turbine 100 according to an embodiment of the present disclosure may ideally comply with the Brayton cycle. The Brayton cycle may consist of four phases including isentropic compression (adiabatic compression), isobaric heat addition, isentropic expansion (adiabatic expansion), and isobaric heat dissipation. In other words, in the Brayton cycle, thermal energy may be released by combustion of fuel in an isobaric environment after the atmospheric air is suctioned and compressed to a high pressure, hot combustion gas may be expanded to be converted into kinetic energy, and exhaust gas with residual energy may then be discharged to the atmosphere. As such, the Brayton cycle may consist of four processes, i.e., compression, heating, expansion, and exhaust.

As illustrated in FIG. 1, the gas turbine 100 employing the Brayton cycle as described above may include a compressor 1000, a combustor 2000, and a turbine 3000. Although the following description will be described with reference to FIG. 1, the description of the present disclosure may be widely applied to a turbine engine having the same configuration as the gas turbine 100 exemplarily illustrated in FIG. 1.

Referring to FIG. 1, the compressor 1000 of the gas turbine 100 may suction and compress air from the outside. The compressor 1000 may supply the air compressed by compressor blades 1100 to the combustor 2000, and may supply cooling air to a high temperature region of the gas turbine 100 where cooling is required to be performed. In this case, since the air suctioned into the compressor 1000 is subject to an adiabatic compression process in the compressor 1000, the pressure and temperature of the air that has passed through the compressor 1000 increase.

The compressor 1000 is usually designed as a centrifugal compressor or an axial compressor. Generally, the centrifugal compressor is applied to a small-scale gas turbine, whereas a multi-stage axial compressor 1000 is applied to the large-scale gas turbine 100 as illustrated in FIG. 1 because it is necessary to compress a large amount of air. In the multi-stage axial compressor 1000, the compressor blades 1100 of the compressor 1000 rotate along with a rotation of rotor disks to compress the introduced air and move the compressed air to compressor vanes 1200 on a rear stage. The air is compressed increasingly to a high pressure while passing through the compressor blades 1100 formed in multiple stages.

A plurality of compressor vanes 1200 may be formed in multiple stages and mounted inside a housing 1300. The compressor vanes 1200 guide the compressed air that flows from the compressor blades 1100 on a front stage toward the compressor blades 1100 on a rear stage. In an embodiment, at least some of the plurality of compressor vanes 1200 may be mounted to be rotatable within a predetermined range for adjustment of an inflow rate of air and so on.

The compressor 1000 may be driven by using some of a power output from the turbine 3000. To this end, as illustrated in FIG. 1, a rotary shaft of the compressor 1000 and a rotary shaft of the turbine 3000 may be directly connected to each other. In the large-scale gas turbine 100, almost half of the output generated from the turbine 3000 may be consumed for driving the compressor 1000. Therefore, improving the efficiency of the compressor 1000 has a direct effect on improving the overall efficiency of the gas turbine 100.

Meanwhile, the combustor 2000 may mix fuel with the compressed air that is supplied from an outlet of the compressor 1000 and perform isobaric combustion, thereby being capable of producing combustion gas with high energy. FIG. 2 is a view illustrating an example of the combustor 2000 applied to the gas turbine 100. The combustor 2000 may further include a burner 2100, a duct assembly 2200, and a combustor casing 2300. The combustor casing 2300 serves to surround a plurality of burners 2100, and may be formed in a substantially cylindrical shape.

The burners 2100 may be disposed on a downstream of the compressor 1000, and may be disposed along the combustor casing 2300 having an annular shape. Each of the burners 2100 includes a plurality of nozzles 2110, and fuel sprayed from the nozzles 2110 is mixed with air at an appropriate ratio so that the mixture thereof is suitable for combustion.

The gas turbine 100 may use gas fuel, especially fuel containing hydrogen. The fuel may be either hydrogen fuel alone or fuel containing hydrogen and natural gas.

Referring to FIG. 2, compressed air is supplied to the nozzles 2110 along an outer surface of the duct assembly 2200 that connects an associated one of the burners 2100 to the turbine 3000 so that hot combustion gas flows through the duct assembly 2200. In this process, the duct assembly 2200 heated by the hot combustion gas is properly cooled.

The duct assembly 2200 may include a liner 2210, a transition piece 2220, and a flow sleeve 2230. The duct assembly 2200 has a double structure in which the flow sleeve 2230 surrounds the outside of the liner 2210 and the transition piece 2220. The liner 2210 and the transition piece 2220 are cooled by the compressed air permeated into a cooling passage 2200a formed inside the flow sleeve 2230.

The liner 2210 is a tubular member connected to the burner 2100 of the combustor 2000, and a space inside the liner 2210 forms a combustion chamber 2400. A first end portion of the liner 2210 in a longitudinal direction is coupled to the burner 2100, and a second end portion of the liner 2210 in the longitudinal direction is coupled to the transition piece 2220.

In addition, the transition piece 2220 is connected to an inlet of the turbine 3000 and serves to guide hot combustion gas to the turbine 3000. A first end portion of the transition piece 2220 in a longitudinal direction is coupled to the liner 2210, and a second end portion of the transition piece 2220 in the longitudinal direction is coupled to the turbine 3000. The flow sleeve 2230 serves to protect the liner 2210 and the transition piece 2220 while preventing high-temperature heat from being directly released to the outside.

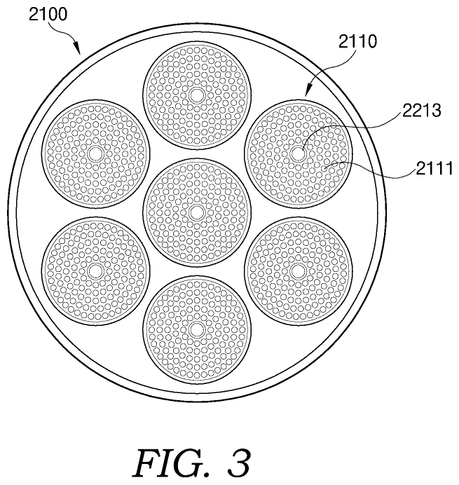

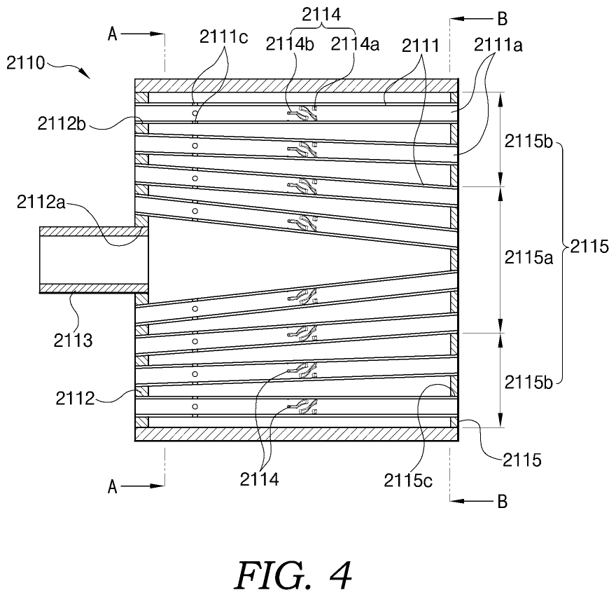

Referring to FIG. 3 and FIG. 4, the nozzle 2110 may include a plurality of mixing tubes 2111, a rear plate 2112, and a fuel supply part 2113, and may further include a mixing mechanism 2114 and a front plate 2115.

The plurality of mixing tubes 2111 spray a mixture fluid in which air and fuel are mixed with each other to the combustion chamber 2400 through a spray hole 2111a, and a rear end of the plurality of mixing tubes 2111 that sprays the mixture fluid to the combustion chamber 2400 is supported by the rear plate 2112.

The fuel supply part 2113 is mounted on the rear plate 2112 that supports the rear end of the plurality of mixing tubes 2111, and the fuel supply part 2113 serves to supply fuel to the plurality of mixing tubes 2111 supported on the rear plate 2112.

An insertion hole 2112a and a plurality of through holes 2112b are formed in the rear plate 2112 that supports the plurality of mixing tubes 2111. The insertion hole 2112a is formed in a center portion of the rear plate 2112, a first end of the fuel supply part 2113 is inserted into the insertion hole 2112a such that the fuel supply part 2113 is mounted in the rear plate 2112. Furthermore, the plurality of through holes 2112b is formed outside the insertion hole 2112a, and each first end of the plurality of mixing tubes 2111 penetrates the plurality of through holes 2112b.

It is preferable that respective mixing mechanisms 2114 are provided in the plurality of mixing tubes 2111, the mixing mechanisms 2114 being configured to mix air supplied inside the mixing tubes 2111 through second ends of the mixing tubes 2111 and fuel supplied through the fuel supply part 2113 and then introduced inside the mixing tubes 2111 with each other.

It is preferable that fuel inlet holes 2111c into which fuel supplied through the fuel supply part 2113 is introduced inside the mixing tubes 2111 are formed in the plurality of mixing tubes 2111. The mixing mechanism 2114 provided in the mixing tube 2111 is provided between the fuel inlet hole 2111c and the spray hole 2111a. The mixing mechanism 2114 is fixed to an inner wall of the mixing tube 2111, and the mixing mechanism 2114 includes a spiral part 2114a connected in a spiral direction and includes a guide plate 2114b which protrudes from the spiral part 2114a toward a side where the inlet hole 2111c is formed and air and fuel are introduced and which is formed of a flat plate. The spiral part 2114a is connected in the spiral direction and induces a rotational flow, and fuel and air may be uniformly mixed with each other by the rotational flow.

Each front end of the plurality of tubes 2111 having each rear end supported by the rear plate 2112 is supported by the front plate 2115. The front plate 2115 is formed in a circular plate shape, includes a center region 2115a which corresponds to the fuel supply part 2113 and which is a center portion of the front plate 2115, and includes an outer region 2115b surrounding the center region 2115a. Furthermore, a plurality of mounting holes 2115c in which the plurality of tubes 2111 that penetrates the through holes 2112b is mounted is formed in the center region 2115a and the outer region 2115b.

A portion of the plurality of mixing tubes 2111 having each first end mounted in the front plate 2115 by penetrating the rear plate 2112 has each spray hole 2111a disposed in the center region 2115a of the front plate 2115 positioned corresponding to the fuel supply part 2113, and the remaining spray holes 211a of the plurality of mixing tubes 2111 are disposed in the outer region 2115b of the front plate 2115.

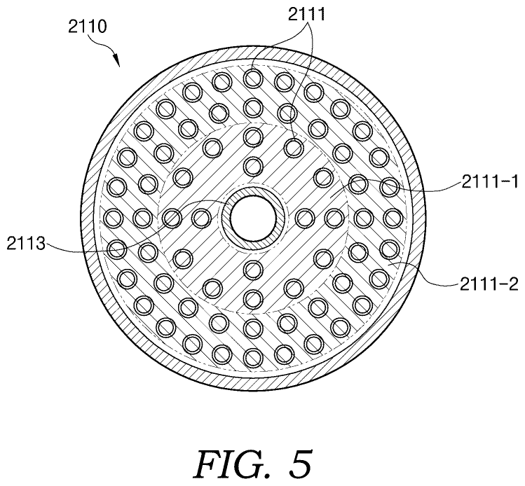

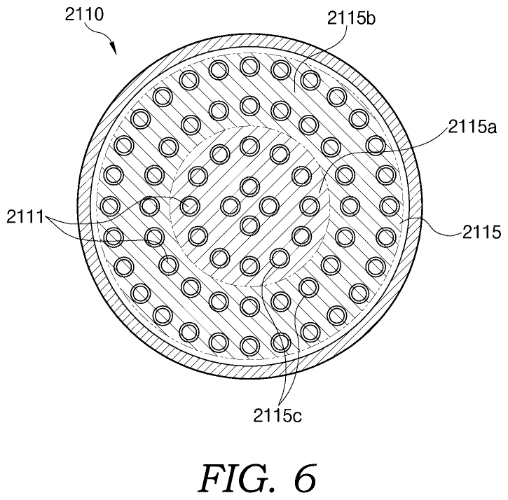

Referring to FIG. 4 to FIG. 6, the plurality of mixing tubes 211 having both ends supported on the rear plate 2112 and the front plate 2115 includes a center nozzle group 2111-1 and an outer nozzle group 2111-2.

The spray holes 2111a in the center nozzle group 2111-1 are disposed in the center region 2115a of the front plate 2115, the spray holes 2111a in the outer nozzle group 2111-2 are disposed in the outer region 2115b of the front plate 2115, and it is preferable that the center nozzle group 2111-1 has a shape inclined toward the center portion of the front plate 2115 between the rear plate 2112 and the front plate 2115.

It is preferable that the plurality of mounting holes 2115c formed in the center region 2115a and the outer region 2115b of the front plate 2115 is evenly distributed at equal intervals on the entire surface of the front plate 2115.

It is preferable that the center nozzle group 2111-1 and the outer nozzle group 2111-2 constituting the plurality of mixing tubes 2111 have angles different from each other, and it is preferable that the plurality of mixing tubes 2111 mounted in the plurality of mounting holes 2115c formed in the front plate 2115 is configured such that each inclination angle of the plurality of mixing tubes 2111 is gradually increased from an outside portion of the front plate 2115 to the center portion of the front plate 2115.

Since the fuel supply part 2113 is mounted in the center portion of the rear plate 2112, the plurality of through holes 2112b through which the plurality of mixing tubes 2111 penetrates is formed outside the insertion hole 2112a into which the fuel supply part 2113 is inserted. Since the plurality of mounting holes 2115c in which the plurality of mixing tubes 2111 having the same number as the plurality of through holes 2112b and penetrating the plurality of through holes 2112b is mounted is evenly formed in the entire surface of the front surface 2115 having the same size as the rear plate 2112, each inclination angle of the mixing tubes 2111 penetrating the through holes 2112b disposed adjacent to the insertion holes 2112a of the rear plate 2112 is large, and each inclination of the mixing tubes 2111 penetrating the through holes 2112b formed toward the outside of the rear plate 2112 becomes gradually lower than each inclination angle of the mixing tubes 2111 penetrating the through holes 2112b disposed adjacent to the insertion hole 2112a.

Therefore, since inclination angles are provided in the mixing tubes disposed adjacent to the fuel supply part in the combustor nozzle of the gas turbine so that each outlet of the plurality of mixing tubes is evenly disposed, an empty space between each of the mixing tubes is not formed by the fuel supply part, so that overheating of each outlet of the mixing tubes due to heat concentration may be prevented. Furthermore, since a self-cooling effect of each of the mixing tubes generated by a low temperature fluid flow in each of the mixing tubes is uniformly applied to the entire outlet surface of the plurality of mixing tubes, each outlet of the mixing tubes may be maintained at a uniform temperature.

While the present disclosure will be described with respect to the embodiment illustrated in the accompanying drawings, this is only for illustrative purposes, and it will be apparent to those skilled in the art that various changes and other equivalent embodiments may be derived from the embodiment. Accordingly, the true technical protection scope of the present disclosure should be determined by the technical spirit of the appended claims.

What is claimed is:

1. A combustor nozzle comprising:
a plurality of mixing tubes configured to spray a mixture fluid in which air and fuel are mixed with each other into respective spray holes;
a rear plate supporting the plurality of mixing tubes at each rear end of the plurality of mixing tubes; and
a fuel supply part mounted in the rear plate and configured to supply fuel,
wherein a portion of the plurality of mixing tubes is formed such that each outlet of the portion of the plurality of mixing tubes is formed at a position corresponding to the fuel supply part.

2. The combustor nozzle of claim 1, further comprising a mixing mechanism provided in each of the plurality of mixing tubes and configured to mix air and fuel that are supplied into the plurality of mixing tubes.

3. The combustor nozzle of claim 1, further comprising a front plate supporting the plurality of mixing tubes at each front end of the plurality of mixing tubes,
wherein the front plate comprises a center region corresponding to the fuel supply part and comprises an outer region surrounding the center region, and
each outlet of a portion of the plurality of mixing tubes is disposed in the center region and each remaining outlet of the plurality of mixing tubes is disposed in the outer region.

4. The combustor nozzle of claim 3, wherein the plurality of mixing tubes comprises:
a center nozzle group having each outlet disposed in the center region; and
an outer nozzle group having each outlet disposed in the outer region.

5. The combustor nozzle of claim 4, wherein an insertion hole into which the fuel supply part is inserted is formed in a center portion of the rear plate, and a plurality of through holes through which the plurality of mixing tubes penetrates is formed outside the insertion hole, and
a plurality of mounting holes in which the plurality of mixing tubes penetrating the plurality of through holes is mounted is formed in the front plate.

6. The combustor nozzle of claim 5, wherein the plurality of mounting holes is evenly distributed at equal intervals on an entire surface of the front plate,
the plurality of mixing tubes is configured such that the center nozzle group and the outer nozzle group have angles different from each other, and
the plurality of mixing tubes mounted in the plurality of mounting holes formed in the front plate is configured such that each inclination angle of the plurality of mixing tubes is gradually increased from an outer portion of the front plate to a center portion of the front plate.

7. The combustor nozzle of claim 2, a fuel inlet hole into which fuel supplied through the fuel supply part is introduced inside each of the plurality of the mixing tubes is formed in each of the plurality of the mixing tubes, and each mixing mechanism is provided between each fuel inlet hole and each spray hole.

8. A combustor comprising:
a burner having a plurality of nozzles for spraying fuel and air; and
a duct assembly coupled to a first side of the burner, the duct assembly having an inner portion where fuel and air sprayed from the burner are combusted and being configured to transmit combustion gas to a turbine,
wherein each of the plurality of nozzles comprises:
a plurality of mixing tubes configured to spray a mixture fluid in which air and fuel are mixed with each other into respective spray holes;
a rear plate supporting the plurality of mixing tubes at each rear end of the plurality of mixing tubes; and
a fuel supply part mounted in the rear plate and configured to supply fuel,
wherein a portion of the plurality of mixing tubes is formed such that each outlet of the portion of the plurality of mixing tubes is formed at a position corresponding to the fuel supply part.

9. The combustor of claim 8, further comprising a mixing mechanism provided in each of the plurality of mixing tubes and configured to mix air and fuel that are supplied into the plurality of mixing tubes.

10. The combustor of claim 8, further comprising a front plate supporting the plurality of mixing tubes at each front end of the plurality of mixing tubes,
wherein the front plate comprises a center region corresponding to the fuel supply part and comprises an outer region surrounding the center region, and
each outlet of a portion of the plurality of mixing tubes is disposed in the center region and each remaining outlet of the plurality of mixing tubes is disposed in the outer region.

11. The combustor of claim 10, wherein the plurality of mixing tubes comprises:
a center nozzle group having each outlet disposed in the center region; and
an outer nozzle group having each outlet disposed in the outer region.

12. The combustor of claim 11, wherein an insertion hole into which the fuel supply part is inserted is formed in a center portion of the rear plate, and a plurality of through holes through which the plurality of mixing tubes penetrates is formed outside the insertion hole, and
a plurality of mounting holes in which the plurality of mixing tubes penetrating the plurality of through holes is mounted is formed in the front plate.

13. The combustor of claim 12, wherein the plurality of mounting holes is evenly distributed at equal intervals on an entire surface of the front plate,
the plurality of mixing tubes is configured such that the center nozzle group and the outer nozzle group have angles different from each other, and
the plurality of mixing tubes mounted in the plurality of mounting holes formed in the front plate is configured such that each inclination angle of the plurality of mixing tubes is gradually increased from an outer portion of the front plate to a center portion of the front plate.

14. The combustor of claim 9, a fuel inlet hole into which fuel supplied through the fuel supply part is introduced inside each of the plurality of the mixing tubes is formed in each of the plurality of the mixing tubes, and each mixing mechanism is provided between each fuel inlet hole and each spray hole.

15. A gas turbine comprising:
a compressor configured to compress air introduced from outside;
a combustor configured to mix fuel with air compressed from the compressor and to combust a mixture thereof; and
a turbine that comprises a plurality of turbine blades configured to be rotated by combustion gas generated from the combustor,
wherein the combustor comprises:
a burner having a plurality of nozzles for spraying fuel and air; and
a duct assembly coupled to a first side of the burner, the duct assembly having an inner portion where fuel and air sprayed from the burner are combusted and being configured to transmit combustion gas to the turbine,
wherein each of the plurality of nozzles comprises:
a plurality of mixing tubes configured to spray a mixture fluid in which air and fuel are mixed with each other into respective spray holes;
a rear plate supporting the plurality of mixing tubes at each rear end of the plurality of mixing tubes; and
a fuel supply part mounted in the rear plate and configured to supply fuel,
wherein a portion of the plurality of mixing tubes is formed such that each outlet of the portion of the plurality of mixing tubes is formed at a position corresponding to the fuel supply part.

16. The gas turbine of claim 15, further comprising a mixing mechanism provided in each of the plurality of mixing tubes and configured to mix air and fuel that are supplied into the plurality of mixing tubes.

17. The gas turbine of claim 16, further comprising a front plate supporting the plurality of mixing tubes at each front end of the plurality of mixing tubes,
wherein the front plate comprises a center region corresponding to the fuel supply part and comprises an outer region surrounding the center region, and
each outlet of a portion of the plurality of mixing tubes is disposed in the center region and each remaining outlet of the plurality of mixing tubes is disposed in the outer region.

18. The gas turbine of claim 17, wherein the plurality of mixing tubes comprises:
a center nozzle group having each outlet disposed in the center region; and
an outer nozzle group having each outlet disposed in the outer region,
wherein an insertion hole into which the fuel supply part is inserted is formed in a center portion of the rear plate, and a plurality of through holes through which the plurality of mixing tubes penetrates is formed outside the insertion hole, and
a plurality of mounting holes in which the plurality of mixing tubes penetrating the plurality of through holes is mounted is formed in the front plate.

19. The gas turbine of claim 18, wherein the plurality of mounting holes is evenly distributed at equal intervals on an entire surface of the front plate,
the plurality of mixing tubes is configured such that the center nozzle group and the outer nozzle group have angles different from each other, and
the plurality of mixing tubes mounted in the plurality of mounting holes formed in the front plate is configured such that each inclination angle of the plurality of mixing tubes is gradually increased from an outer portion of the front plate to a center portion of the front plate.

20. The gas turbine of claim 16, a fuel inlet hole into which fuel supplied through the fuel supply part is introduced inside each of the plurality of the mixing tubes is formed in each of the plurality of the mixing tubes, and each mixing mechanism is provided between each fuel inlet hole and each spray hole.
